(19) United States
(12) Patent Application Publication
(10) Pub. No.: US 2019/0166653 A1
(43) Pub. Date: May 30, 2019

(54) POSITIVE TEMPERATURE COEFFICIENT (PTC) HEATER

(71) Applicant: Mahle International GmbH, Stuttgart (DE)

(72) Inventors: Michael Kohl, Bietigheim-Bissingen (DE); Eric Marlier, Kolbsheim (FR); Stefan Paetzold, Stuttgart (DE); David Rollet, Carspach (FR); Falk Viehrig, Stuttgart (DE); Denis Wiedmann, Wallhausen (DE)

(21) Appl. No.: 16/199,842

(22) Filed: Nov. 26, 2018

(30) Foreign Application Priority Data
Nov. 27, 2017 (EP) 17203815.0

(51) Int. Cl. H05B 3/14; H05B 3/26; H05B 3/28

(52) U.S. Cl. CPC H05B 3/14; H05B 3/262; H05B 2203/02; H05B 2203/013; H05B 3/283

(57) ABSTRACT

A positive temperature coefficient (PTC) heater may include a housing and at least one PTC heating element arranged within the housing. The at least one PTC heating element may include a heating layer of a PTC material arranged between two electrode plates of the at least one PTC heating element and electrically contacted therewith. The two electrode plates may be fixed to the housing such that heat is transferable and and the two electrode plates are electrically insulated from the housing. At least one electrically insulated heat conducting layer may be arranged to divide the heating layer into a divided heating layer and may be fixed to the divided heating layer to transfer heat.

### CROSS-REFERENCE TO RELATED APPLICATION

This application claims priority to European Application No. EP 17203815.0, filed on Nov. 27, 2017, the contents of which are hereby incorporated by reference in its entirety.

### TECHNICAL FIELD

The invention relates to a PTC heater comprising at least one PTC heating element.

### BACKGROUND

Modern motor vehicles are increasingly optimized for consumption and less and less waste heat is available for conventionally heating the interior. In particular when cold starting the motor vehicle and in the case of low outside temperatures, the interior can be additionally heated for example by means of a PTC (Positive Temperature Coefficient) heater. PTC heaters are already known from the prior art and are made of typically ceramic PTCs, which are characterized by an electrical resistance, which increases as the temperature increases. The PTC heater is throttled by its own behavior and the heating surfaces of the PTC heater have an even temperature distribution. The temperature of the heating surfaces is in particular independent of boundary conditions—such as for example of the applied voltage, the resistance of the PTC or the air quantity above the PTC heater. The PTC heater is cost-efficient, can be installed in air ducts of the air conditioning system in a space-saving manner and quickly converts the electrical energy into the heat.

In hybrid or electric vehicles, a PTC heater has a particularly high significance, because no waste heat or only a small amount of waste heat is produced in a hybrid or electric vehicle, and can be used for heating. For an effective heating in a hybrid or electric vehicle, the PTC heater needs to partially convert a wattage of more than 3 kW into heat. This is why the PTC heater is operated at a high voltage in order to keep the current as low as possible. The voltages are thereby above 60 V and partially above 300 V. To rule out exposure of the passengers during operation of the PTC heater, the PTC heater needs to also be touch-protected and flashover-protected. Voltage conducting components of the PTC heater need to furthermore be encapsulated in a dust-tight and water-tight manner. To meet the increasing demands on the touch protection, the voltage conducting components are electrically insulated to the outside to an increasing extent. The heat release of the PTC heater to the outside, which causes an unwanted throttling of the PTC heater, is also reduced thereby. The wattage, which the PTC heater can convert into the heat, is also reduced accordingly.

### SUMMARY

It is thus the object of the invention to specify an improved or at least alternative embodiment for a PTC heater of the generic type, in the case of which the described disadvantages are overcome.

According to the invention, this object is solved by the subject matter of the independent claim(s). Advantageous further embodiments are the subject matter of the dependent claim(s).

The invention at hand is based on the general idea of improving the heat release to the outside in a PTC heater comprising at least one PTC heating element and to thus prevent an unwanted throttling of the PTC heater. The at least one PTC heating element thereby has a heating layer of a PTC material, which is arranged between two electrode plates and which is electrically contacted therewith. The PTC heater further has a housing, in which the at least one PTC heating element is arranged. The electrode plates of the at least one PTC heating element are thereby fixed to the housing so as to transfer heat and so as to be electrically insulated. According to the invention, at least one electrically insulated heat conducting layer divides the heating layer and is fixed to the divided heating layer so as to transfer heat. Advantageously, the at least one heat conducting layer has a heat conductivity, which is higher as compared to the heating layer, and dissipates the heat generated in the heating layer to the outside. Advantageously, an unwanted throttling of the PTC heating element is thus prevented. The heat conducting layer is electrically insulated from the heating layer, so that the heat conducting layer does not influence electrical properties of the PTC heating element.

Advantageously, the heating layer can be made of the sintered PTC material, which preferably has barium titanate or consists thereof. The heating layer of sintered barium titanate has a heat conductivity of approximately 2 W/mK. The at least one heat conducting layer can for example consist of a sintered ceramic, which preferably has aluminum nitride or boron nitride, or consists thereof. In the case of the sintered aluminum nitride, the heat conducting layer has a heat conductivity of approximately 130 W/mK and in the case of the sintered boron nitride a heat conductivity of approximately 60 W/mK. The heat conducting layer of one of these materials can effectively dissipate the heat generated in the heating layer to the outside and can thus prevent an unwanted throttling of the PTC heating element and of the PTC heater. In the alternative, the at least one heat conducting layer can be a metal plate, which is electrically insulated from the divided heating layer by means of an insulating coating. The insulating coating is preferably an oxide layer or a varnish or an insulating film.

In the case of an advantageous embodiment of the PTC heater according to the invention, provision is made for the at least one heat conducting layer to extend from the one electrode plate to the other electrode plate and to divide the heating layer vertically to the electrode plates. The at least one heat conducting layer thereby abuts on both sides of the divided heating layer so as to transfer heat and can dissipate the heat generated in the heating layer via the electrode plates. On both sides of the housing, the electrodes plates arranged on the housing and electrically insulated therefrom in each case form a heating surface, at which the heat generated in the heating layer is released into the surrounding area. The heat can be released more effectively to the electrode plates and to the respective heating surfaces of the housing by means of the at least one heat conducting layer.

The heating layer can in particular be divided into a plurality of individual heating part layers, wherein the respective heating part layers and the respective heat conducting layers are arranged so as to alternate and vertically to the electrode plates. The heat generated in the heating layer can be dissipated evenly from the PTC heating element in this way and an unwanted throttling of the PTC heating element and of the PTC heater can be prevented thereby in an advantageous manner. The respective heat conducting layer is thereby electrically insulated from the divided heating layer and the electrode plates, so that electrical properties of the PTC heating element and of the PTC heater are not influenced.

In the case of an advantageous further development of the PTC heater according to the invention, provision is made for at least one heat conducting layer to extend in parallel to the electrode plates and to divide the heating layer in parallel to the electrode plates. The at least one heat conducting layer can dissipate the heat, which is only dissipated slowly via the heating layer itself, from a middle area of the heating layer. An unwanted throttling of the PTC heating element and of the PTC heater can be prevented in an advantageous manner thereby. The at least one heat conducting layer is electrically insulated from the divided heating layer and the electrode plates and does not influences electrical properties of the PTC heating element and of the PTC heater in this way.

To effectively dissipate the heat from the at least one heat conducting layer to the outside, a heat distribution body of the PTC heating element can be fixed to the at least one heat conducting layer on one side and to the housing on the other side so as to transfer heat. The heat distribution body can consist for example of a sintered ceramic, which is preferably an aluminum nitride or a boron nitride. The heat distribution body dissipates the heat from the at least one heat conducting layer to the housing, to which the heat distribution body is fixed so as to transfer heat, and thus forms at least one body heating surface of the PTC heater. The heating surface is expanded in an advantageous manner by means of the body heating surface and the heat generated in the PTC heating element can be released into the surrounding area in a large-scale and even manner.

Provision can advantageously be made for an electrically insulating insulating plate to be arranged in each case between the electrode plates and the housing. The respective insulating plate is fixed to the housing so as to transfer heat and electrically insulates the electrode plates from the housing. The PTC heater is protected against touch and flashover in this way. The respective insulating plate can additionally be connected to the heat distribution body of the PTC heating element so as to transfer heat, in order to be able to effectively release the heat generated in the PTC heating element to the heating surface and to the body heating surface. Advantageously, the respective insulating plate can consist of an aluminum oxide or a sintered ceramic, preferably an aluminum nitride or a boron nitride.

As a whole, the heat generated in the heating layer is dissipated to the outside in an improved manner and an unwanted throttling of the PTC heating element is thereby prevented in an advantageous manner by means of the PTC heater according to the invention. Furthermore, the heat output of the PTC heating element and of the PTC heater is increased thereby.

Further important features and advantages of the invention follow from the subclaims, from the drawings, and from the corresponding figure description by means of the drawings.

It goes without saying that the above-mentioned features and the features, which will be explained below, cannot only be used in the respective specified combination, but also in other combinations or alone, without leaving the scope of the invention at hand.

Preferred exemplary embodiments of the invention are illustrated in the drawings and will be explained in more detail in the description below, whereby identical reference numerals refer to identical or similar or functionally identical components.

### BRIEF DESCRIPTION OF THE DRAWINGS

In each case schematically

FIGS. 1 and 2 show sectional views of a PTC heater according to the invention;

FIG. 3 shows a view of a PTC heater according to the invention according to FIG. 1 and FIG. 2;

FIGS. 4 and 5 show sectional views of a PTC heater according to the invention in an alternative embodiment;

FIG. 6 shows views of PTC heater according to the invention according to FIG. 4 and FIG. 5 comprising a heat distribution body.

### DETAILED DESCRIPTION

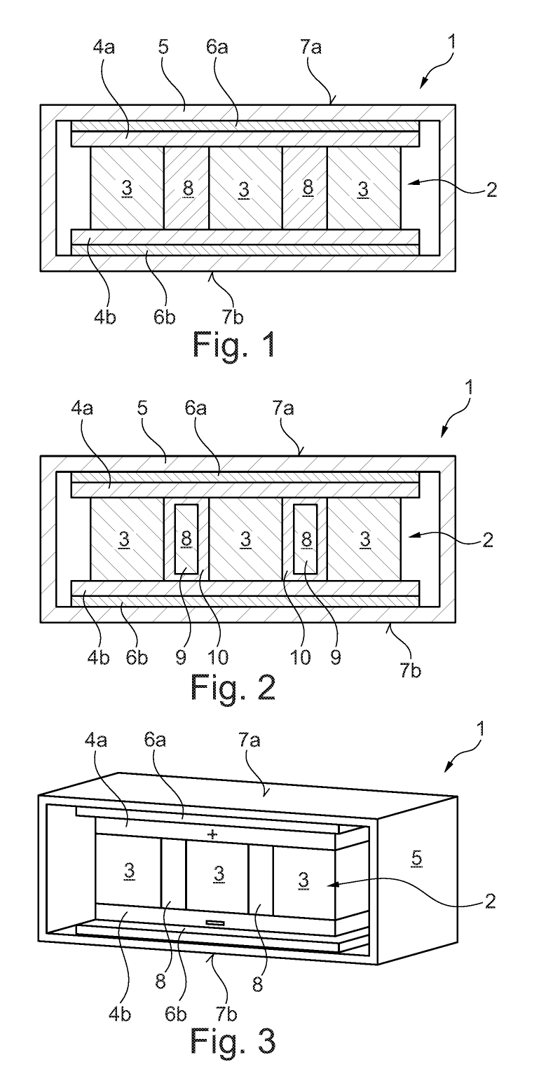

FIG. 1 and FIG. 2 show sectional views of a PTC heater 1 according to the invention. FIG. 3 shows a perspective view of the PTC heater 1. The PTC heater 1 thereby has a PTC heating element 2 comprising a heating layer 3, which is arranged between two electrode plates 4a and 4b and which is electrically contacted therewith. The heating layer 3 is made of a PTC material, which preferably has barium titanate or consists thereof. The PTC heating element 2 is encapsulated in a housing 5 of the PTC heater 1 in a dust-tight and water-tight manner, wherein insulating plates 6a and 6b are arranged between the electrode plates 4a and 4b and the housing 5. The respective insulating plates 6a and 6b are fixed to the housing 5 so as to transfer heat and electrically insulate the electrode plates 4a and 4b from the housing 5. The PTC heater 1 is protected against touch and flashover in this way. The insulating plates 6a and 6b can consist for example of an aluminum oxide. The heat generated in the heating layer 3 is released to heating surfaces 7a and 7b of the housing 5 via the electrode plates 4a and 4b as well as the insulating plates 6a and 6b.

In FIG. 1 and FIG. 2, two heat conducting layers 8 divide the heating layer 3 vertically to the electrode plates 4a and 4b and abut on both sides of the heating layer 3 so as to transfer heat. As shown in FIG. 1, the respective heat conducting layer 8 can consist for example of a sintered ceramic, which is preferably an aluminum nitride or a boron nitride. In the case of the sintered aluminum nitride, the heat conducting layer 8 then has a heat conductivity of approximately 130 W/mK and a heat conductivity of approximately 60 W/mk in the case of the sintered boron nitride. In contrast, the heating layer 3 of the sintered barium titanate has a heat conductivity of approximately 2 W/mK. The heat conducting layer 8 can effectively dissipate the heat generated in the heating layer 3 to the electrode plates 4a and 4b and can prevent an unwanted throttling of the PTC heating element 2 and of the PTC heater 1 thereby. The respectively heat conducting layer 8 of aluminum nitride or boron nitride is also electrically insulating, so that electrical properties of the PTC heating element 2 are not influenced by the heat conducting layers 8. As an alternative to FIG. 1, the respective heat conducting layer 8 in FIG. 2 is a metal plate 9, which is electrically insulated from the divided heating layer 3 and the electrode plates 4a and 4b by means of an insulating coating 10. The insulating coating 10 can for example be an oxide layer or a varnish or an insulating film. Here, the respective heat conducting layers 8 also have a higher heat conductivity than the heating layer 3.

As shown in FIG. 3, a voltage is applied to the electrode plates 4a and 4b and the wattage is converted into the heat in the heating layer 3. When the temperature rises, the resistance of the heating layer 3 rises as well and the PTC heating element 2 throttles to a constant temperature by means of its own behavior. The respective heat conducting layers 8 have a higher heat conductivity than the heating layer 3 and dissipate the heat generated in the heating layer 3 to the electrode plates 4a and 4b and to the housing 5 via the insulating plates 6a and 6b. The heating surfaces 7a and 7b then release the heat to the surrounding area. As a whole, the heat generated in the heating layer 3 in this way can be dissipated evenly from the PTC heating element 2 in this way and an unwanted throttling of the PTC heating element 2 and of the PTC heater 1 can be prevented in an advantageous manner thereby. The respective heat conducting layer 8 is thereby electrically insulated from the divided heating layer 3 and the electrode plates 4a and 4b, so that electrical properties of the PTC heating element 2 and of the PTC heater 1 are not influenced.

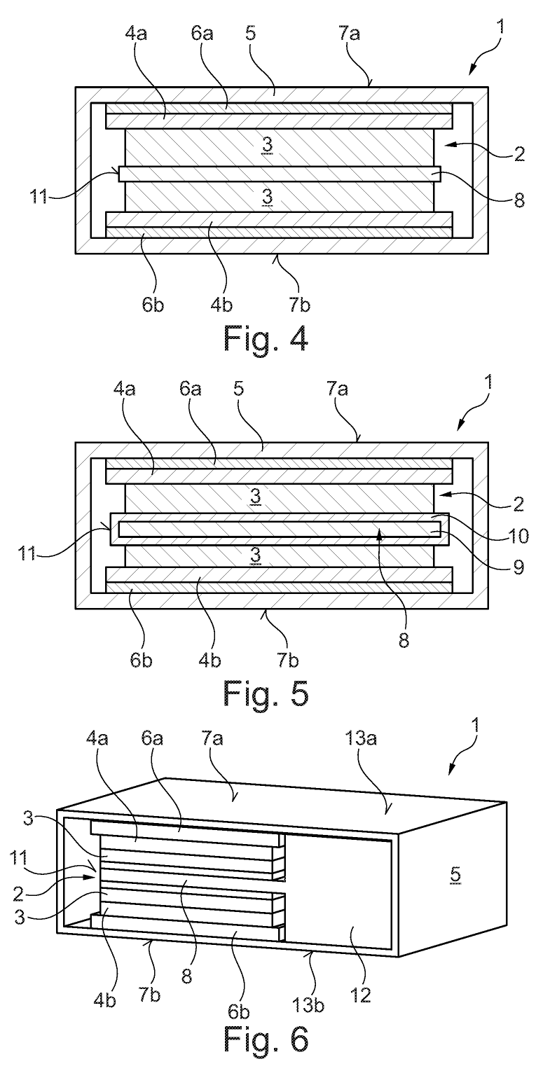

FIG. 4 and FIG. 5 show sectional views of the PTC heater 1 according to the invention in an alternative embodiment. The heat conducting layer 8 extends in parallel to the electrode plates 4a and 4b and divides the heating layer 3 parallel to the electrode plates 4a and 4b. The heat conducting layer 8 can dissipate the heat from a middle area 11 of the heating layer 3 in a particularly effective manner in this way. In FIG. 4, the heat conducting layer 8 consists of a sintered ceramic, which preferably has aluminum nitride or boron nitride, or consists thereof. In FIG. 5, the heat conducting layer 8 is the metal plate 9 comprising the insulating coating 10. The insulating coating 10 can for example be an oxide layer or a varnish or an insulating film. In both cases, the heat conducting layer 8 has a higher heat conductivity than the heating layer 3 and can effectively dissipate the heat from the middle area 11 of the heating layer 3.

In FIG. 6, the heat conducting layer 8 is further connected to the housing 5 via a heat distribution body 12 of the PTC heating element 2 so as to transfer heat. The heat distribution body 12 can consist for example of a sintered ceramic, which is preferably an aluminum nitride or a boron nitride. The heat distribution body 12 dissipates the heat, which is released into the surrounding area at body heating surfaces 13a and 13b from the heat conducting layer 8 to the housing 5. The body heating surface 13a and 13b connect to the heating surfaces 7a and 7b of the PTC heater 1 and the heat generated in the PTC heating element 2 can be released into the surrounding area in a large-scale and effective manner.

As a whole, the heat generated in the PTC heater 1 according to the invention in the heating layer 3 can be effectively dissipated to the outside and an unwanted throttling of the PTC heating element 2 can be prevented in an advantageous manner thereby. Furthermore, the heat output of the PTC heating element 2 and of the PTC heater 1 is increased thereby.

1. A positive temperature coefficient (PTC) heater comprising:
at least one PTC heating element including a heating layer of a PTC material arranged between two electrode plates of the at least one PTC heating element and electrically contacted therewith; and
a housing, in which the at least one PTC heating element is arranged;
wherein the two electrode plates are fixed to the housing such that heat is transferable and the two electrode plates are electrically insulated from the housing; and
wherein at least one electrically insulated heat conducting layer is arranged to divide the heating layer into a divided heating layer and is fixed to the divided heating layer to transfer heat.

2. The PTC heater according to claim 1, wherein the at least one heat conducting layer extends from one of the two electrode plates to the other of the two electrode plates and divides the heating layer in a direction extending between the two electrode plates.

3. The PTC heater according to claim 1, wherein the at least one heat conducting layer extends parallel to the two electrode plates and divides the heating layer in a direction parallel to the two electrode plates.

4. The PTC heater according to claim 3, wherein a heat distribution body of the at least one PTC heating element is fixed to the at least one heat conducting layer on one side and to the housing on another side facilitating a transfer of heat therebetween.

5. The PTC heater according to claim 4, wherein the heat distribution body is composed of a sintered ceramic.

6. The PTC heater according to claim 1, wherein at least one of:
the at least one heat conducting layer is composed of a sintered ceramic; and
the heating layer is composed of a sintered PTC material.

7. The PTC heater according to claim 1, wherein the at least one heat conducting layer is a metal plate, which is electrically insulated from the divided heating layer via an insulating coating.

8. The PTC heater according to claim 1, further comprising two electrically insulating insulating plates each coupling a respective electrode plate of the two electrode plates to the housing to transfer heat, wherein each of the two insulating plates is arranged between the respective electrode plates and the housing.

9. The PTC heater according to claim 8, wherein at least one of the two insulating plates is connected to a heat distribution body of the at least one PTC heating element to transfer heat.

10. The PTC heater according to claim 8, wherein the two insulating plates are composed of at least one of an aluminum oxide, a sintered ceramic, an aluminum nitride, and a boron nitride.

11. The PTC heater according to claim 1, wherein the at least one heat conducting layer is composed of a sintered ceramic including at least one of aluminum nitride and boron nitride.

12. The PTC heater according to claim 1, wherein the heating layer is composed of a sintered PTC material including barium titanate.

13. The PTC heat according to claim 5, wherein the sintered ceramic includes at least one of aluminum nitride and boron nitride.

14. The PTC heater according to claim 7, wherein the insulating coating is one of an oxide layer, a varnish, and an insulating film.

15. A positive temperature coefficient (PTC) heater comprising a housing and at least one PTC heating element arranged within the housing, the at least one PTC heating element including:
two electrode plates configured to be coupled to the housing such that heat is transferable therebetween and the two electrode plates are electrically insulated from the housing;
a plurality of heating layers of a PTC material arranged between and electrically contacting the two electrode plates; and
at least one electrically insulated heat conducting layer alternating arranged with the plurality of heating layers, the at least one heat conducting layer coupled to the plurality of heating layers in a heat transferring manner.

16. The PTC heater according to claim 15, wherein the at least one heat conducting layer and the plurality of heating layers extend between the two electrode plates.

17. The PTC heater according to claim 15, wherein the at least one heat conducting layer and the plurality of heating layers extend parallel to the two electrode plates.

18. The PTC heater according to claim 15, wherein the at least one heat conducting layer includes an insulating coating electrically insulating the at least one heat conducting layer from the plurality of heating layers.

19. A positive temperature coefficient (PTC) heater comprising a housing and at least one PTC heating element arranged within the housing, the at least one PTC heating element including:
two electrode plates;
two electrically insulating insulating plates configured to be arranged between the two electrode plates and the housing, each of the two insulating plates configured to be a respective electrode plate of the two electrode plates to the housing such that heat is transferable therebetween and the two electrode plates are electrically insulated from the housing;
a plurality of heating layers of a PTC material arranged between and electrically contacting the two electrode plates; and
at least one electrically insulated heat conducting layer alternating arranged with the plurality of heating layers, the at least one heat conducting layer coupled to the plurality of heating layers in a heat transferring manner.

20. The PTC heater according to claim 19, wherein the at least one PTC heating element further includes a heat distribution body coupled to the at least one heat conducting layer on one side and configured to be coupled to the housing on another side facilitating a transfer of heat therebetween.
